(19) United States
(12) Patent Application Publication
(10) Pub. No.: US 2026/0005627 A1
(43) Pub. Date: Jan. 1, 2026

(54) BRAKING TORQUE REGULATION OF A MULTI-PHASE MOTOR DURING BATTERY POWER UNAVAILABILITY

(71) Applicant: Infineon Technologies Austria AG, Villach (AT)

(72) Inventors: Tomasz Kowalczyk, Villach (AT); Nikola Ivic, Villach (AT); Nitin Agarwal, Torrance, CA (US)

(21) Appl. No.: 18/760,594

(22) Filed: Jul. 1, 2024

(51) Int. Cl. H02P 6/24; H02P 6/08

(52) U.S. Cl. CPC H02P 6/24; H02P 6/08

(57) ABSTRACT

An apparatus, including: a multi-phase motor having stator windings; an inverter connected between a direct current (DC) supply voltage and ground, and having power switches connected to the stator windings of the multi-phase motor; and a motor controller operable to regulate a braking torque of the multi-phase motor during periods of battery power unavailability by applying control signals to the power switches in the inverter to boost the DC supply voltage using back electromagnetic force (BEMF) voltage induced in the stator windings, passively brake the multi-phase motor, or plug brake the multi-phase motor, for each phase of the multi-phase motor, based on the DC supply voltage, a rotor position of the multi-phase motor, and an angular speed of the multi-phase motor.

### BACKGROUND

Autonomous lawnmowers are designed to operate across varied terrains, including those with uphill and downhill gradients. A challenge arises when there is a battery pack failure while the mower is on a downhill slope. In such scenarios, the lawnmower may start freewheeling downhill, creating a risk of unintended acceleration and potential collisions with obstacles or individuals.

During such incidents, the motion of the lawnmower converts the wheel motors into generators. As the wheels rotate, they generate a back electromotive force (BEMF), which is subsequently converted by an inverter into a rectified voltage. This rectified voltage temporarily substitutes for the primary battery supply, acting as an emergency power supply.

To control the descent of the lawnmower under these conditions, current designs incorporate a braking mechanism that involves shorting the low-side power switches in two of the three phases in the inverter. The un-shorted phase is then used to boost the power voltage through a boost converter principle, which utilizes pulse width modulation (PWM) on both the low-side and high-side power switches. This approach is intended to generate higher supply voltage for prolonged inverter operation and allow lower rotations per minute (RPM) than simply activating the low-side power switches of all three phases. However, this system does not regulate the amount of braking torque applied, leading to potential instability and jerky lawnmower movements due to the continuous toggling of the system on and off.

### BRIEF DESCRIPTION OF THE FIGURES

FIG. 1 illustrates a schematic diagram of a lawnmower, in accordance with aspects of the disclosure.

FIG. 2 illustrates a circuit diagram of an apparatus, in accordance with aspects of the disclosure.

FIG. 3A illustrates a schematic diagram of a motor controller of the apparatus of FIG. 2, in accordance with aspects of the disclosure.

FIG. 3B illustrates a waveform diagram depicting an exemplary pulse width modulation (PWM) drive sequence during boosting.

FIG. 3C illustrates a waveform diagram depicting an exemplary PWM drive sequence during passive braking.

FIG. 3D illustrates a waveform diagram depicting an exemplary PWM drive sequence during plug braking.

FIG. 4A illustrates a waveform diagram that plots angular speed against hill angle, in accordance with aspects of the disclosure.

FIG. 4B illustrates a waveform diagram showing the variation of supply voltage versus angular speed, in accordance with aspects of the disclosure.

FIG. 5 illustrates a waveform diagram of back electromotive force (BEMF) and exemplary PWM drive sequences during boosting, passive braking, and plug braking across a 30-390° commutation cycle, in accordance with aspects of the disclosure.

FIG. 6A illustrates a waveform diagram showing exemplary PWM drive sequences of an inverter and supply voltage across a commutation cycle for a conventional apparatus.

FIG. 6B illustrates a waveform diagram showing exemplary PWM drive sequences of the apparatus of FIG. 2 alongside supply voltage across a commutation cycle, in accordance with aspects of the disclosure

FIGS. 7A and 7B illustrate waveform diagrams showing exemplary PWM drive sequences of the apparatus of FIG. 2 and supply voltage over a commutation cycle for different duty cycles, in accordance with aspects of the disclosure.

### DETAILED DESCRIPTION

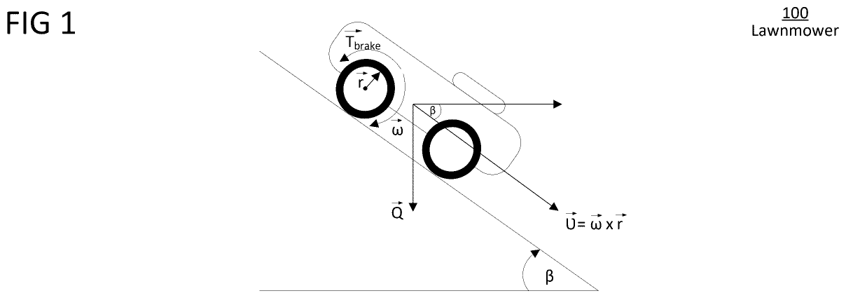

FIG. 1 illustrates a schematic diagram of an autonomous lawnmower 100, in accordance with aspects of the disclosure. This autonomous lawnmower 100 is equipped with a motor controller, which is further discussed below. The motor controller is designed to adaptively control the braking torque \vec{T_{brake}} of the lawnmower's motor. This adaptive control system is intended to either maintain or adjust the braking torque \vec{T_{brake}} while also preserving the motor's supply voltage V_{DC} for as long as possible during incidents such as a battery pack failure or similar situations where normal power supply is disrupted. The motor controller is operable to regulate the lawnmower's angular speed ω or linear speed υ as it navigates downhill at an incline β. Additionally, it can prolong the duration of controlled braking until the supply voltage V_{DC} falls below a set threshold. Gravity is represented as \vec{Q}. While these features are described in the context of an autonomous lawnmower, they are also relevant and applicable to other battery-operated devices vulnerable to power failures, such as drone quadcopters.

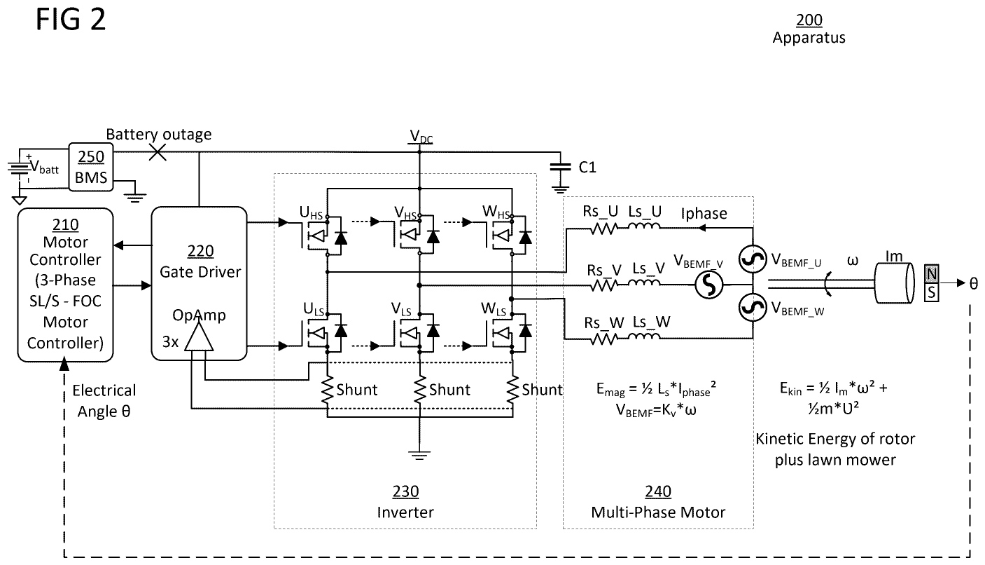

FIG. 2 illustrates a circuit diagram of apparatus 200, in accordance with aspects of the disclosure. Apparatus 200 is operable to deliver adaptive, stable braking torque that facilitates controlled braking, rolling, and descent without requiring additional external components. For instance, apparatus 200 could correspond to lawnmower 100 depicted in FIG. 1.

The apparatus 200 of this example comprises numerous components: a motor controller 210, a gate driver 220, an inverter 230, a motor 240, and a battery management system (BMS) 250.

Motor 240 is a multi-phase motor, potentially configured as a multi-phase permanent magnet synchronous motor (PMSM) or a multi-phase externally excited synchronous motor (EESM). It includes stator windings and a permanent magnet rotor (PMSM) or rotor with wound copper wires (EESM). The motor 240 generally has a phase count that is a multiple of three. In this example, motor 240 includes three phases U, V, and W.

Inverter 230, which is connected between the supply voltage V_{DC} and ground, includes stages connected to respective phases (stator windings) of the motor 240. Each stage has complementary power switches (high-side U_{HS}, V_{HS}, W_{HS} and low-side U_{LS}, V_{LS}, W_{LS} transistors) and freewheeling rectifiers, facilitating the conversion of mechanical rotation in the motor into electrical energy and vice versa.

Gate driver 220 drives the power switches U_{HS}, V_{HS}, W_{HS}, U_{LS}, V_{LS}, W_{LS}, and is connected between the supply voltage V_{DC} and ground. The supply voltage V_{DC} is applied to the high-side power switch U_{HS}, V_{HS}, W_{HS} to supply load current to the stator windings. Conversely, the ground is connected to the low-side power switch U_{LS}, V_{LS}, W_{LS}, which sinks the load current from the stator windings. These complementary power switches are alternately activated and deactivated to prevent cross-conduction, ensuring efficient and safe operation of the motor control system.

Motor controller 210 regulates braking torque of the motor 240 during periods of battery power unavailability by control signals to the power switches U_{HS}, U_{LS}, V_{HS}, V_{LS}, W_{HS}, W_{LS} in the inverter 230. It boosts the supply voltage V_{DC}, applies passive braking, and/or applies plug braking depending on the motor's electrical angle θ. Specifically, the motor controller 210 regulates braking torque by boosting the supply voltage V_{DC} using BEMF voltage induced in the stator windings, passively brakes the motor 240, or plug brakes the motor 240, for each phase of the motor 240, based on the supply voltage V_{DC}, the motor's electrical angle θ, and the motor's angular speed ω. The supply voltage boosting, passive braking, or plug braking are described in more detail below.

The motor controller 210 is exemplified as a three-phase, sensorless (SL)/sensored field-oriented control (FOC) motor controller in this disclosure. However, the scope of the disclosure is not limited to this particular configuration. Various other suitable motor controller configurations can be utilized as required to meet specific application needs.

The magnetic energy E_{mag} of the stator winding is used to determine available recuperative energy at the moment of failure and is based on phase current Iₚₕₐₛₑ and inductance of the phases Lₛ. The magnetic energy E_{mag} is represented as:

$${E}_{mag} = \frac{1}{2} {L}_{s} * {I}_{phase}^{2} , \qquad ( Equation 1 )$$

The BEMF voltage V_{BEMF} is represented as:

$${V}_{BEMF} = {K}_{v} * ω \qquad ( Equation 2 )$$

where Kᵥ represents a BEMF constant that is a motor parameter that varies depending on the motor construction, and ω represents the angular speed of the rotor.

The BEMF voltage V_{BEMF} is rectified by the inverter 230, which effectively increases the direct current supply voltage V_{DC}.

The kinetic energy Eₖᵢₙ of the rotor plus the lawnmower 100, or any other moving object, is presented as:

$${E}_{kin} = \frac{1}{2} {I}_{m} * {ω}^{2} + \frac{1}{2} m * {U}^{2} , \qquad ( Equation 3 )$$

where υ represents the speed of the lawnmower 100, Iₘ, represents the moment of inertia of the rotor, and m represents the mass of the lawnmower 100. The kinetic energy Eₖᵢₙ increases as the wheels of the lawnmower 100 rotate. This is the energy that corresponds to the braking torque needed.

BMS 250 monitors and manages the primary battery's voltage V_{batt}, and health but is not the focus of this disclosure. Detailed functionalities of BMS 250 are thus omitted for brevity.

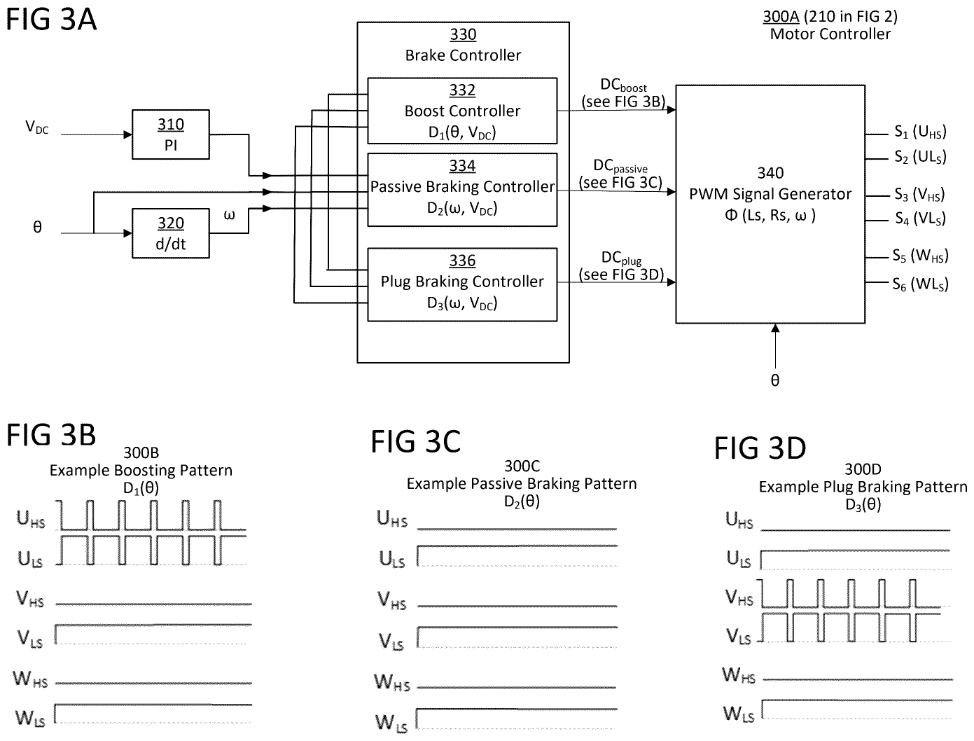

FIG. 3A illustrates a schematic diagram of a motor controller 300A (210 in FIG. 2) of apparatus 200 of FIG. 2, in accordance with aspects of the disclosure.

The motor controller 300A includes a number of components: a proportional-integral (PI) controller 310, a differentiator 320, a brake controller 330, and a pulse width modulation (PWM) signal generator 340. These components work in concert to manage and optimize the motor's performance efficiently.

PI controller 310 is designed to correct deviations between a target setpoint and an actual observed value, utilizing feedback from the supply voltage V_{DC}. While PI controllers are well-established in various applications, alternative options such as proportional-integral-derivative (PID) controllers might also be employed to enhance control dynamics. Additionally, the motor controller 210 is capable of controlling individual phases of motor 240 in both linear and non-linear manners, depending on the specific requirements of the operation.

The differentiator 320 functions to produce an output for angular speed ω, which is directly proportional to the rate of change of the electrical angle θ.

The brake controller 330 encompasses three functional components: a boost controller 332, a passive braking controller 334, and a plug braking controller 336. While depicted as distinct controllers, these components may be integrated into a single physical controller. Similarly, the PI controller 310, the differentiator 320, and the brake controller 330, though presented as separate units, can be consolidated into a single unit.

The brake controller 330 is designed to evaluate the optimal braking strategy—whether to boost the supply voltage V_{DC}, engage in passive braking, or initiate plug braking—for each phase of motor 240. This decision is informed by the current supply voltage V_{DC}, the electrical angle θ (indicating rotor position), and the angular speed ω of motor 240. Based on these inputs, the brake controller 330 selects an appropriate pattern or a combination of patterns to control the PWM signal generator 340 to result in a precise amount of desired braking torque.

The pulse width modulation (PWM) signal generator 340 generates PWM control signals S₁, S₂, S₃, S₄, S₅, S₆ to adaptively adjust a PWM duty cycle D of the power switches U_{HS}, U_{LS}, V_{HS}, V_{LS}, W_{HS}, W_{LS} in the inverter 230. This adjustment is tailored for each phase of the motor 240, based on the supply voltage V_{DC}, the electrical angle θ, and the angular speed ω. The PWM control signals S₁, S₂, S₃, S₄, S₅, S₆ are applied to either the low-side power switch U_{LS}, V_{LS}, W_{LS} or the high-side power switch U_{HS}, V_{HS}, W_{HS} of the respective inverter stage of the motor 240, with the PWM duty cycle D influencing the extent to which the supply voltage V_{DC} is boosted or the motor is plug braked. The motor controller 300A shorts to ground the low-side power switch U_{LS}, V_{LS}, W_{LS} or the high-side power switch U_{HS}, V_{HS}, W_{HS} of each of the remaining inverter stages of the motor 240. The motor controller 210 boosts the supply voltage V_{DC}, passively brakes the motor 240, or plug brakes the motor 240 dependent on the electrical angle θ of motor 240.

FIG. 3B illustrates a waveform diagram 300B depicting an exemplary PWM drive sequence during boosting. Motor controller 300A boosts the supply voltage V_{DC}, which is subsequently utilized for plug braking. To facilitate this, the motor controller 210 halts the commutation of motor 240 and permits apparatus 200 to coast downhill by switching off all power switches U_{HS}, V_{HS}, W_{HS}, U_{LS}, V_{LS}, W_{LS} in the inverter 230. The current generated from the BEMF voltage of motor 240 flows back through the anti-parallel diodes of these power switches, where it is rectified to recharge the supply voltage V_{DC} (stored in capacitor C1). As the process unfolds, motor 240 gradually decelerates due to passive and plug braking, effectively serving as a braking mechanism until it stops.

During normal operation, motor 240 is driven by a control algorithm designed to achieve a specific speed, which correlates with an electrical frequency. However, when braking is required, motor 240 is slowed by generating a negative braking torque. There are two primary methods of braking: passive braking and plug (active) braking.

During passive braking, the motor controller 210 grounds either the low-side power switches U_{LS}, V_{LS}, W_{LS} or the high-side power switches U_{HS}, V_{HS}, W_{HS} of any number of inverter stages of the motor 240. This action enables the BEMF current generated in motor 240 to circulate through the stator windings, thus stopping the rotation of motor 240. Specifically, as the rotor continues to spin inside the stator, the change in magnetic flux in the stator windings resulting from the rotation of the rotor results in a BEMF voltage developing on the stator windings. Short-circuiting the windings completes the circuit, allowing the BEMF-induced current to flow through the stator windings and generate opposing magnetic field to the rotor magnetic field, thus generating a passive braking force to stop the rotation of the rotor.

When two of three inverter stages are shorted, a specific PWM drive sequence is applied for the remaining stage of inverter 230. FIG. 3C illustrates a waveform diagram 300C when all three inverter stages are shorted during passive braking. This configuration results in the maximum passive braking torque achievable.

Plug braking offers greater braking power compared to passive braking by using energy from the supply voltage V_{DC} to exert a negative torque on motor 240. In scenarios where the battery V_{batt} is unavailable, the available energy from the supply voltage V_{DC}, though limited, is typically adequate to facilitate effective plug braking while maintain V_{DC} inside the regulated limits.

Plug braking operates by reversing the direction of the revolving magnetic field within motor 240. This is achieved by altering the phase sequence of the supply voltage to the stator windings, which creates an opposing torque against the motor's current direction of rotation. As a result, motor 240 encounters resistance from this opposing torque and is quickly decelerated. Following this, the motor 240 may attempt to rotate in the reverse direction. If apparatus 200 is positioned on a high incline, this reverse motion is typically impractical, as the uphill force required would be substantial, preventing apparatus 200 from moving backward.

The PWM drive sequence is employed to regulate the intensity, or gain, of the plug braking torque. The PWM duty cycle D is dynamically adjusted for each phase individually, influenced by the supply voltage V_{DC} and the angular speed ω. This adjustment allows precise control over the boost voltage and braking torque, offering substantial flexibility in managing both boosting and plug braking. Such regulation prevents apparatus 200 from shutting down if the supply voltage V_{DC} drops below a certain threshold. FIG. 3D provides a waveform diagram 300D, showcasing an exemplary PWM drive sequence during plug braking.

The motor controller 210 calibrates the PWM duty cycle D₁, D₂ and D₃ based on the brake controller 330 for the phase power switches U_{HS}, V_{HS}, W_{HS}, U_{LS}, V_{LS}, W_{LS} based on the supply voltage V_{DC} (rectified BEMF), to optimize both boosting and plug braking. The maximum angular speed ω is obtained when all phases' low sides are floating, whereas maximum braking torque occurs when all low-side power switches U_{LS}, V_{LS}, W_{LS} are shorted to ground. The higher the supply voltage V_{DC} generated, the greater the braking capability, allowing the motor controller 210 to convert more kinetic energy back into electrical energy. Conversely, when the supply voltage V_{DC} is low, braking should be minimized to conserve energy; instead, allowing the lawnmower 100 to accelerate slightly can help rebuild the supply voltage V_{DC}. The motor controller 210 also adjusts its control strategy based on the lawnmower's weight and inertia and the specific conditions of its application.

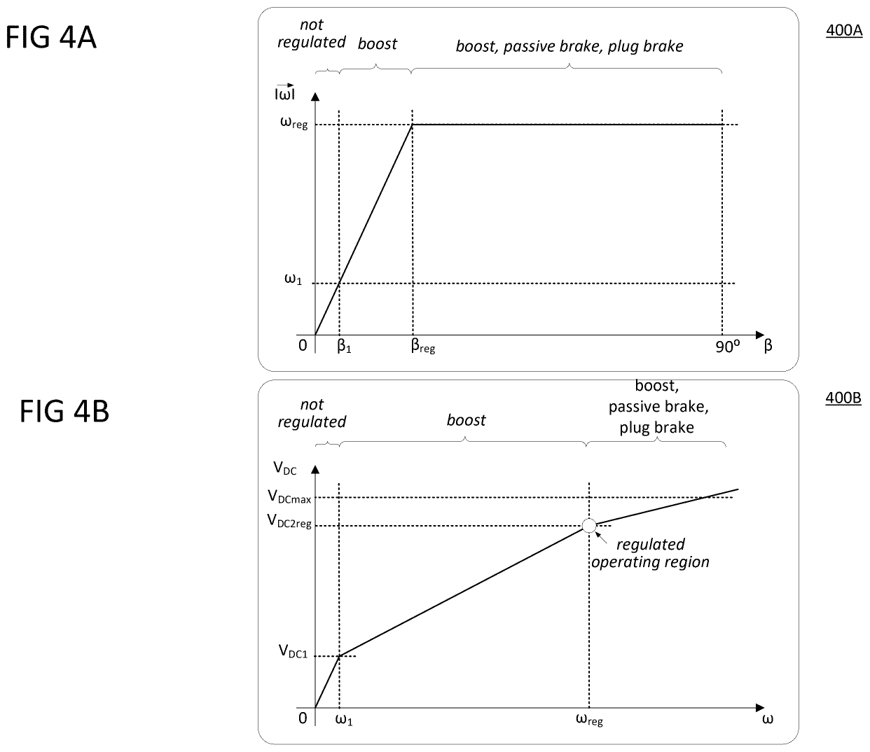

FIG. 4A illustrates a waveform diagram 400A that plots angular speed against hill angle, in accordance with aspects of the disclosure. FIG. 4B illustrates a waveform diagram 400B showing the variation of supply voltage V_{DC} versus angular speed ω, in accordance with aspects of the disclosure.

Upon the initial unavailability of battery power V_{batt}, motor 240 can function in a generator mode, utilizing the BEMF voltage generated in the stator windings to boost the supply voltage V_{DC}. The motor controller 210 starts to regulate the braking torque of motor 240 once the supply voltage V_{DC} surpasses a defined threshold V_{DC2reg} or the angular speed w of motor 240 exceeds a specified threshold W_{reg}. This approach allows lawnmower 100 (apparatus 200) to initially increase speed, harnessing the BEMF to boost the supply voltage V_{DC} to a level sufficient for initiating passive braking.

Once the supply voltage V_{DC} reaches a sufficiently high level, entering a saturated state, the motor controller 210 may transition from passive to plug braking. Initially, the motor controller 210 applies passive braking; if this does not provide adequate braking torque, it switches to plug braking, which significantly enhances the braking force. This shift not only effectively slows down lawnmower 100 but also serves as a protective measure against overvoltage by reducing the supply voltage V_{DC}.

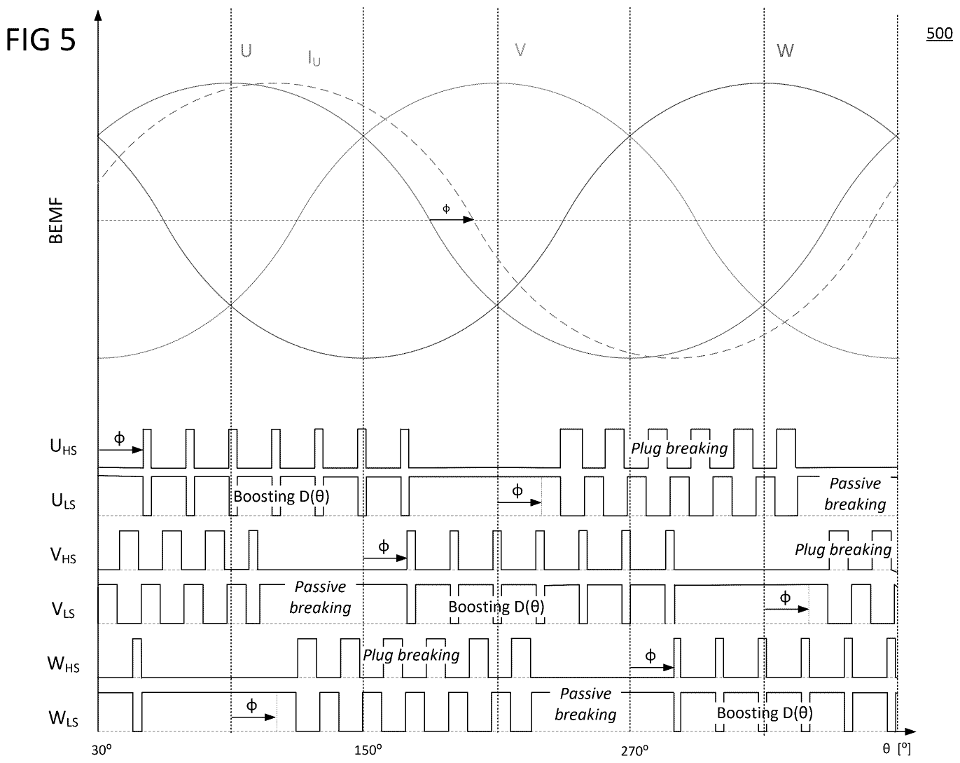

FIG. 5 illustrates a waveform diagram 500 of BEMF and exemplary PWM drive sequences during boosting, passive braking, and plug braking across a 30-390° commutation cycle, in accordance with aspects of the disclosure.

The commutation patterns of the PWM drive sequences in the example are determined based on BEMF unique to each phase. As depicted, the first electrical angle θ shown, there is a boosting PWM drive sequence applied only to the U phase. Concurrently, the V phase undergoes passive braking, while the W phase may undergo plug braking. Thus, each phase—U, V, W—can have a distinct PWM drive sequence.

Furthermore, the same PWM drive sequence can serve either for boosting or for plug braking, depending on the electrical angle θ and polarity of the BEMF voltage. For instance, within the 30-90° sector, the PWM switching sequence for the U phase is configured for boosting. If this identical switching sequence were applied to the V phase, it would result in plug braking instead of boosting due to the BEMF voltage being positive for phase U but negative for phase V.

The displacement angle ϕ is attributed to phase current's lag relative to the corresponding BEMF voltage.

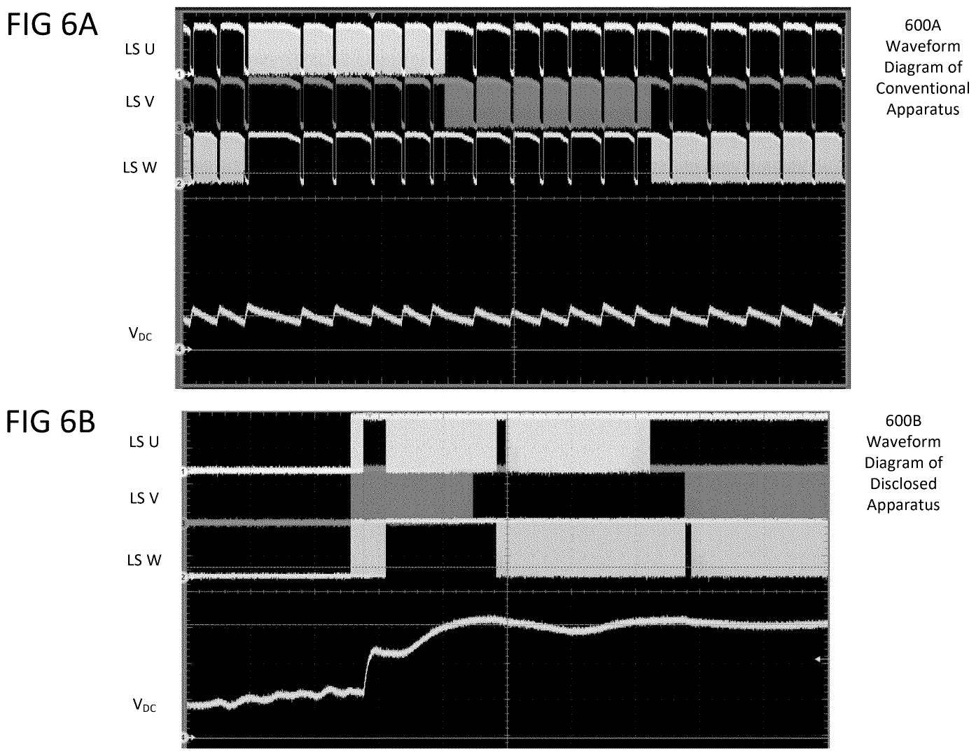

FIG. 6A illustrates a waveform diagram 600A showing exemplary PWM drive sequences of an inverter and supply voltage V_{DC} for a conventional apparatus. In contrast, FIG. 6B illustrates a waveform diagram 600B showing exemplary PWM drive sequences of the apparatus 200 of FIG. 2 alongside supply voltage V_{DC} across a commutation cycle, demonstrating an advantage of aspects of the disclosure. As can be seen, the disclosed apparatus 200 boosts the supply voltage V_{DC} to a higher level compared with conventional systems. Additionally, the supply voltage V_{DC} of apparatus 200 exhibits reduced ripple effects because it is not turning on and off, and begins generating significant voltage at a lower speed as compared with prior solutions.

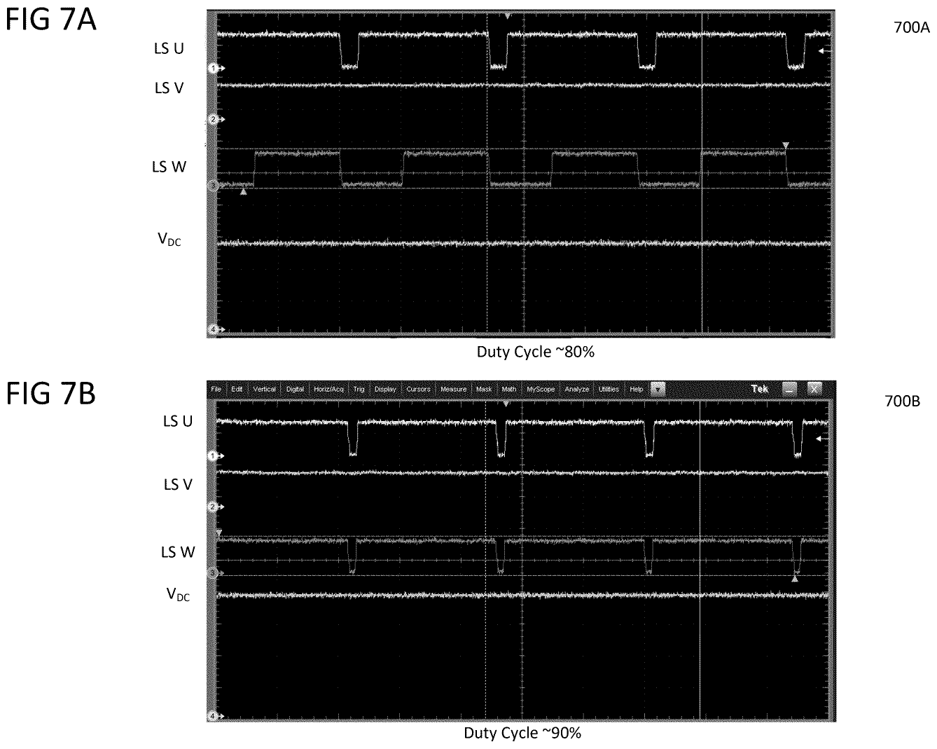

FIGS. 7A and 7B illustrate waveform diagrams 700A and 700B, respectively, showing exemplary PWM drive sequences of apparatus 200 of FIG. 2 and supply voltage V_{DC} over a commutation cycle for different duty cycles, in accordance with aspects of the disclosure. Waveform diagram 700A shows a duty cycle of approximately 80%, while waveform diagram 700B shows a duty cycle of approximately 90%. These diagrams 700A, 700B highlight the impact of different duty cycles on the apparatus' performance and the associated supply voltage V_{DC} levels.

Furthermore, aspects of the present disclosure can be realized through a computer program. This program can integrate with hardware components to control the braking torque of a multi-phase motor as described herein. The program is stored on a computer-readable medium, enabling a computer to execute the functions specified by the disclosed aspects.

Aspects detailed in this disclosure may be implemented in software, accessible via various computer technologies, and stored on a computer-readable medium. This medium may store program instructions, data files, and data structures, either individually or in combination. The program instructions may be tailored for the disclosed aspects or may be known to those skilled in the field of computer software. Examples of such media include magnetic media such as hard disks and magnetic tapes; optical media such as CDs and DVDs; and magneto-optical media. Additionally, electronic devices such as ROM, RAM, and flash memory can be specially configured to store and execute these instructions. These program instructions could be written in low-level machine language produced by compilers or in high-level languages executable via interpreters. Furthermore, these electronic devices may be adapted to function as one or more software modules to carry out operations of the invention, or conversely, software modules may be adapted to operate on these devices.

The techniques of this disclosure may also be described in the following examples.

Example 1. An apparatus, comprising: a multi-phase motor having stator windings; an inverter connected between a direct current (DC) supply voltage and ground, and having power switches connected to the stator windings of the multi-phase motor; and a motor controller operable to regulate a braking torque of the multi-phase motor during periods of battery power unavailability by applying control signals to the power switches in the inverter to boost the Supply voltage using back electromagnetic force (BEMF) voltage induced in the stator windings, passively brake the multi-phase motor, or plug brake the multi-phase motor, for each phase of the multi-phase motor, based on the DC supply voltage, a rotor position of the multi-phase motor, and an angular speed of the multi-phase motor.

Example 2. The apparatus of example 1, wherein the motor controller is operable to apply the control signals to the power switches in the inverter to boost the DC supply voltage, passively brake, or plug brake the multi-phase motor depending on an electrical angle of the multi-phase motor.

Example 3. The apparatus of any of examples 1-2, wherein the motor controller is operable to plug brake the multi-phase motor using energy from the DC supply voltage to apply a negative braking torque in the multi-phase motor.

Example 4. The apparatus of any of examples 1-3, wherein the motor controller comprises: a pulse width modulation (PWM) signal generator operable to generate PWM control signals to adaptively adjust a PWM duty cycle of the power switches in the inverter for each of the phases of the multi-phase motor, based on the DC supply voltage, the electrical angle, and the angular speed.

Example 5. The apparatus of any of examples 1-4, wherein the inverter comprises inverter stages, each having a low-side power switch and a high-side power switch, connected to respective phases of the multi-phase motor.

Example 6. The apparatus of any of examples 1-5, wherein the motor controller is operable to boost the DC supply voltage, passive brake, or plug brake the multi-phase motor by: applying the PWM control signals to the low-side power switch or the high-side power switch of at least one of the inverter stages of the multi-phase motor, wherein the PWM duty cycle corresponds with a magnitude that the DC supply voltage is boosted, and shorting to ground the low-side power switch or the high-side power switch of each of the remaining inverter stages of the multi-phase motor, wherein the operability of the motor controller to boost the DC supply voltage, passive brake the multi-phase motor, or plug brake the multi-phase motor is based on the electrical angle of the multi-phase motor.

Example 7. The apparatus of any of examples 1-6, wherein the motor controller is operable to passively brake the multi-phase motor by: shorting to ground the low-side or high-side power switches of two or more of the inverter stages of the multi-phase motor.

Example 8. The apparatus of any of examples 1-7, wherein when the battery power initially becomes unavailable, the multi-phase motor is operable in a generator mode to boost the DC supply voltage using the BEMF voltage induced in the stator windings.

Example 9. The apparatus of any of examples 1-8, wherein the motor controller is operable to begin regulating the braking torque of the multi-phase motor when the DC supply voltage is boosted to exceed a threshold DC supply voltage or the angular speed of the multi-phase motor exceeds a threshold angular speed.

Example 10. The apparatus of any of examples 1-9, wherein the multi-phase motor is a multi-phase permanent magnet motor having a number of phases that is a multiple of three.

Example 11. The apparatus of any of examples 1-10, wherein the motor controller is operable to control each of the phases of the multi-phase motor either linearly or non-linearly.

Example 12. The apparatus of any of examples 1-11, wherein: the multi-phase motor is a multi-phase permanent magnet synchronous motor (PMSM), and the apparatus further comprises a permanent magnet rotor, or the multi-phase motor is a multi-phase externally excited synchronous motor (EESM), and the apparatus further comprises stator windings and a rotor having wound copper wires.

Example 13. A method for regulating braking torque of a multi-phase motor connected to an inverter connected between a direct current (DC) supply voltage and ground, the inverter having power switches connected to stator windings of the multi-phase motor, the method comprising: determining when battery power is unavailable to the multi-phase motor; and for each phase of the multi-phase motor, applying control signals to the power switches in the inverter to boost the DC supply voltage using back electromagnetic force (BEMF) voltage induced in the stator windings, passively brake the multi-phase motor, or plug brake the multi-phase motor, based on the DC supply voltage, a rotor position, and an angular speed of the multi-phase motor.

Example 14. The method of example 13, further comprising: applying the control signals to the power switches in the inverter to boost the DC supply voltage, passively brake, or plug brake the multi-phase motor depending on an electrical angle of the multi-phase motor.

Example 15. The method of any of examples 13-14, further comprising: plug braking the multi-phase motor using energy from the DC supply voltage to apply a negative braking torque in the multi-phase motor.

Example 16. The method of any of examples 13-15, further comprising: generating, by a pulse width modulation (PWM) signal generator, PWM control signals to adaptively adjust a PWM duty cycle of the power switches in the inverter for each of the phases of the multi-phase motor, based on the DC supply voltage, the electrical angle, and the angular speed.

Example 17. The method of any of examples 13-16, wherein the inverter comprises inverter stages, each having a low-side power switch and a high-side power switch, connected to respective phases of the multi-phase motor.

Example 18. The method of any of examples 13-17, further comprising: boosting the DC supply voltage, passive braking, or plug braking the multi-phase motor by: applying the PWM control signals to the low-side power switch or the high-side power switch of at least one of the inverter stages of the multi-phase motor, wherein the PWM duty cycle corresponds with a magnitude that the DC supply voltage is boosted, and shorting to ground the low-side power switch or the high-side power switch of each of the remaining inverter stages of the multi-phase motor, wherein the boosting the DC supply voltage, passive braking the multi-phase motor, or plug braking the multi-phase motor is based on the electrical angle of the multi-phase motor.

Example 19. The method of any of examples 13-18, wherein when the battery power initially becomes unavailable, the method further comprises: boosting the DC supply voltage using the BEMF voltage induced in the stator windings.

Example 20. The method of any of examples 13-19, further comprising: begin regulating the braking torque of the multi-phase motor when the DC supply voltage is boosted to exceed a threshold DC supply voltage or the angular speed of the multi-phase motor exceeds a threshold angular speed.

While the foregoing has been described in conjunction with exemplary embodiment, it is understood that the term “exemplary” is merely meant as an example, rather than the best or optimal. Accordingly, the disclosure is intended to cover alternatives, modifications and equivalents, which may be included within the scope of the disclosure.

Although specific embodiments have been illustrated and described herein, it will be appreciated by those of ordinary skill in the art that a variety of alternate and/or equivalent implementations may be substituted for the specific embodiments shown and described without departing from the scope of the present disclosure. This disclosure is intended to cover any adaptations or variations of the specific embodiments discussed herein.

What is claimed is:

1. An apparatus, comprising:
a multi-phase motor having stator windings;
an inverter connected between a direct current (DC) supply voltage and ground, and having power switches connected to the stator windings of the multi-phase motor; and
a motor controller operable to regulate a braking torque of the multi-phase motor during periods of battery power unavailability by applying control signals to the power switches in the inverter to boost the DC supply voltage using back electromagnetic force (BEMF) voltage induced in the stator windings, passively brake the multi-phase motor, or plug brake the multi-phase motor, for each phase of the multi-phase motor, based on the DC supply voltage, a rotor position of the multi-phase motor, and an angular speed of the multi-phase motor.

2. The apparatus of claim 1, wherein the motor controller is operable to apply the control signals to the power switches in the inverter to boost the DC supply voltage, passively brake, or plug brake the multi-phase motor depending on an electrical angle of the multi-phase motor.

3. The apparatus of claim 2, wherein the motor controller is operable to plug brake the multi-phase motor using energy from the DC supply voltage to apply a negative braking torque in the multi-phase motor.

4. The apparatus of claim 2, wherein the motor controller comprises:
a pulse width modulation (PWM) signal generator operable to generate PWM control signals to adaptively adjust a PWM duty cycle of the power switches in the inverter for each of the phases of the multi-phase motor, based on the DC supply voltage, the electrical angle, and the angular speed.

5. The apparatus of claim 4, wherein the inverter comprises inverter stages, each having a low-side power switch and a high-side power switch, connected to respective phases of the multi-phase motor.

6. The apparatus of claim 5, wherein the motor controller is operable to boost the DC supply voltage, passive brake, or plug brake the multi-phase motor by:
applying the PWM control signals to the low-side power switch or the high-side power switch of at least one of the inverter stages of the multi-phase motor, wherein the PWM duty cycle corresponds with a magnitude that the DC supply voltage is boosted, and
shorting to ground the low-side power switch or the high-side power switch of each of the remaining inverter stages of the multi-phase motor,
wherein the operability of the motor controller to boost the DC supply voltage, passive brake the multi-phase motor, or plug brake the multi-phase motor is based on the electrical angle of the multi-phase motor.

7. The apparatus of claim 5, wherein the motor controller is operable to passively brake the multi-phase motor by:
shorting to ground the low-side or high-side power switches of two or more of the inverter stages of the multi-phase motor.

8. The apparatus of claim 1, wherein when the battery power initially becomes unavailable, the multi-phase motor is operable in a generator mode to boost the DC supply voltage using the BEMF voltage induced in the stator windings.

9. The apparatus of claim 8, wherein the motor controller is operable to begin regulating the braking torque of the multi-phase motor when the DC supply voltage is boosted to exceed a threshold DC supply voltage or the angular speed of the multi-phase motor exceeds a threshold angular speed.

10. The apparatus of claim 1, wherein the multi-phase motor is a multi-phase permanent magnet motor having a number of phases that is a multiple of three.

11. The apparatus of claim 1, wherein the motor controller is operable to control each of the phases of the multi-phase motor either linearly or non-linearly.

12. The apparatus of claim 1, wherein:
the multi-phase motor is a multi-phase permanent magnet synchronous motor (PMSM), and the apparatus further comprises a permanent magnet rotor, or
the multi-phase motor is a multi-phase externally excited synchronous motor (EESM), and the apparatus further comprises stator windings and a rotor having wound copper wires.

13. A method for regulating braking torque of a multi-phase motor connected to an inverter connected between a direct current (DC) supply voltage and ground, the inverter having power switches connected to stator windings of the multi-phase motor, the method comprising:
determining when battery power is unavailable to the multi-phase motor; and
for each phase of the multi-phase motor, applying control signals to the power switches in the inverter to boost the DC supply voltage using back electromagnetic force (BEMF) voltage induced in the stator windings, passively brake the multi-phase motor, or plug brake the multi-phase motor, based on the DC supply voltage, a rotor position, and an angular speed of the multi-phase motor.

14. The method of claim 13, further comprising:
applying the control signals to the power switches in the inverter to boost the DC supply voltage, passively brake, or plug brake the multi-phase motor depending on an electrical angle of the multi-phase motor.

15. The method of claim 14, further comprising:
plug braking the multi-phase motor using energy from the DC supply voltage to apply a negative braking torque in the multi-phase motor.

16. The method of claim 14, further comprising:
generating, by a pulse width modulation (PWM) signal generator, PWM control signals to adaptively adjust a PWM duty cycle of the power switches in the inverter for each of the phases of the multi-phase motor, based on the DC supply voltage, the electrical angle, and the angular speed.

17. The method of claim 16, wherein the inverter comprises inverter stages, each having a low-side power switch and a high-side power switch, connected to respective phases of the multi-phase motor.

18. The method of claim 17, further comprising:
boosting the DC supply voltage, passive braking, or plug braking the multi-phase motor by:
applying the PWM control signals to the low-side power switch or the high-side power switch of at least one of the inverter stages of the multi-phase motor, wherein the PWM duty cycle corresponds with a magnitude that the DC supply voltage is boosted, and
shorting to ground the low-side power switch or the high-side power switch of each of the remaining inverter stages of the multi-phase motor,
wherein the boosting the DC supply voltage, passive braking the multi-phase motor, or plug braking the multi-phase motor is based on the electrical angle of the multi-phase motor.

19. The method of claim 13, wherein when the battery power initially becomes unavailable, the method further comprises:
boosting the DC supply voltage using the BEMF voltage induced in the stator windings.

20. The method of claim 19, further comprising:
begin regulating the braking torque of the multi-phase motor when the DC supply voltage is boosted to exceed a threshold DC supply voltage or the angular speed of the multi-phase motor exceeds a threshold angular speed.
